(19) United States
(12) Patent Application Publication
(10) Pub. No.: US 2010/0102475 A1
(43) Pub. Date: Apr. 29, 2010

(54) EXPANDED POLYSTYRENE RECYCLING AND HEAT EXTRUDING SYSTEM

(76) Inventors: Yongsoon Moon, River Edge, NJ (US); Daniel Chung, Wayne, NJ (US); Wonyong Cho, Leonia, NJ (US)

Correspondence Address: Lauson & Tarver LLP, 880 Apollo Street, SUITE 301, El Segundo, CA, 90245, US

(21) Appl. No.: 12/259,877

(22) Filed: Oct. 28, 2008

(51) Int. Cl. B29C 47/38; B29C 47/96; B29C 47/92

(52) U.S. Cl. 264/211.21; 425/162; 425/151; 425/160

(57) ABSTRACT

An expanded polystyrene (EPS) recycling and extruding machine is shown and described. The machine comprises a conveyor for transporting waste pieces of EPS of various sizes into the device. A housing surrounds upper and lower crushers that break down the EPS pieces in to progressively smaller pieces before depositing them through a screen that selectively prevents pieces above a predetermined size from passing. Below the screen, the small EPS pieces fall into a heated extruding mechanism that melts the pieces into a liquid and urges the liquid forward by means of an Archimedian screw to a nozzle, through which the reconstituted EPS is extruded for collection and reuse.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

Expanded polystyrene (EPS) is a commonly used material for packing and packaging. Due to the quantities of EPS used in commerce, it is advantageous to recycle EPS wherever possible so that it can be reused. However, EPS at room temperature is a solid that cannot be reformed without destroying its shape. Therefore, a means for reconstituting EPS into an extruded ingot provides a means for recycling EPS.

It is therefore an object of the present invention to provide an EPS recycling and extruding machine that can accept a variety of sizes and shapes of waste EPS material to be recycled. A further object of the invention is to provide an EPS recycling and extruding machine that comprises a means for crushing waste EPS pieces until they can be melted and extruded. Still another object of the invention is to provide an EPS recycling and extruding machine that has controls allowing the machine to be pre-heated, activated, and the machine's speed adjusted, and further comprises emergency shut off controls. These and other object of the invention will become apparent through the appended summary, description and claims.

### SUMMARY

An expanded polystyrene recycling and extruding device comprises a conveyor belt with a tensioner and motor for moving waste expanded polystyrene (EPS) pieces into the body of the device. A crusher accepts the waste EPS pieces and reduces their size. The crusher comprises an intake housing surrounding an upper crusher with at least one row of teeth for breaking down EPS. The EPS then falls into a lower crusher to be broken down into even smaller pieces. The lower crusher comprises two rows of crusher gears. Below the lower crusher, a screen retains EPS pieces larger than a predetermined size, and allows sufficiently reduced pieces of EPS to pass through.

An extruder accepts the EPS pieces that fall through the screen. The extruder comprises a heated housing for melting the EPS and an Archimedian screw comprising an auger for moving the melted EPS to an extruding nozzle along the axis of rotating helical flighting. The heated housing comprises heating elements, and in one preferred embodiment, the elements comprise three distinct heating zones capable of reaching different temperatures for progressively heating and melting the EPS.

A controller is associated with the device for controlling the various motors and heating elements. The controller has controls for altering and setting the speed of the conveyor motor and belt, and the speed of the upper and lower crushers. The temperature of the heating elements, including each section of heating elements, and the speed of the extruder is also controlled by controlling the extruder motor.

In preferred embodiments of the device, a hopper channels crushed EPS from the lower crusher into the extruder. A back door is disposed on the housing allows access to the upper and lower crushers for maintenance, and a ventilation panel allows gasses to escape from the device.

In another preferred embodiment, a smaller version of the device is shown, comprising a single housing with a control panel. In this embodiment, the controller comprises a touch display for controlling the motors and heating elements.

In order to use the device of the present invention, a user places waste EPS into the device. The device is then activated so that recycling can begin. EPS is fed through the upper and lower crushers, and falls through the screen into the heating element where it melts and the auger urges it, as a liquid, through the nozzle of the extruder. A means for collecting the extruded EPS is placed under the nozzle. After the device has processed the lasts of the EPS, and the last of the EPS has left the nozzle, the device can be deactivated.

### BRIEF DESCRIPTION OF THE FIGURES

FIG. 1 is a perspective view of an expanded polystyrene recycling and extruding device.

FIG. 2 is a side view of an expanded polystyrene recycling and extruding device.

FIG. 3 is a front view of an expanded polystyrene recycling and extruding device.

FIG. 4 is a perspective view of a stand-alone unit expanded polystyrene recycling and extruding device.

FIG. 5 is a diagram of the control interface of an expanded polystyrene recycling and extruding device.

### DETAILED DESCRIPTION

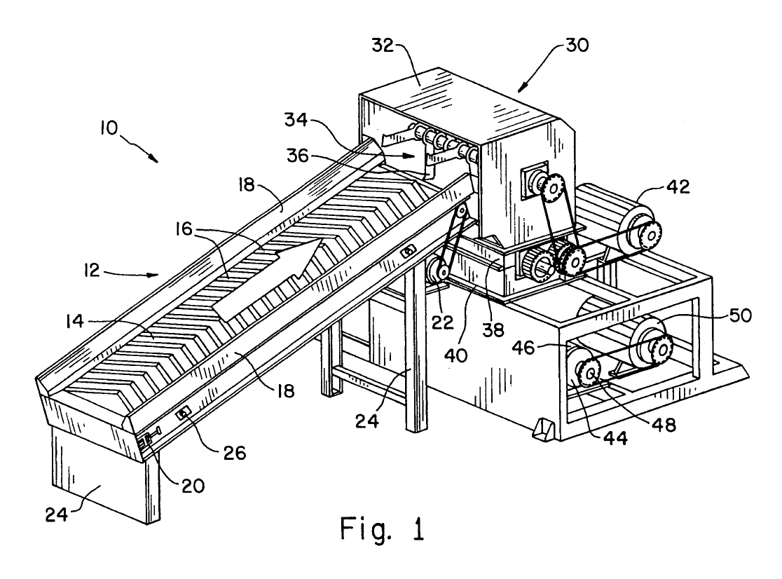

Referring to FIG. 1, an expanded polystyrene recycling and extruding device is shown and described. The device 10 comprises a conveyor 12 for moving pieces of waste expanded polystyrene (EPS). The conveyor 12 further comprises a conveyor belt 14, and in one preferred embodiment, the belt 14 comprises a means 16 for preventing EPS from slipping back down the belt. In one embodiment, the means 16 for preventing slippage may comprise ridges. In another preferred embodiment, the conveyor 12 comprises sidewalls 18 to prevent EPS from moving laterally off the belt 14.

In order to keep the belt 14 taught and in motion, a tensioner 20 is disposed at one extreme end of the belt, and a motor 22 is associated with the belt. Supports 24 hold the conveyor 12 at an angle to move EPS up and into the subsequent parts of the device, and an emergency cut-off switch 26 is associated with the conveyor for halting operation in an emergency.

Still referring to FIG. 1, a crusher 30 accepts pieces of waste EPS, and reduces their size prior to melting. The crusher 30 comprises an intake housing 32, surrounding an upper crusher 34. The upper crusher 34 comprises at least one row of members 36 for breaking down EPS to a predetermined maximum size. Once EPS is broken down by the upper crusher 36, it falls into a lower crusher 38 to be broken down into smaller pieces. The lower crusher 38 comprises two rows of crusher gears (not shown) to reduce EPS pieces to a second predetermined maximum size. Below the lower crusher 38, a screen 40 retains EPS pieces larger than a predetermined size, and allows sufficiently reduced pieces of EPS to pass through. A crusher motor 42 causes the upper crusher 36 and lower crusher 38 to operate in tandem.

Still referring to FIG. 1, an extruder 44 accepts the EPS pieces that fall through the screen The extruder 44 comprises a heated housing 46 for melting the EPS and an Archimedian screw (not shown), comprising an auger for moving the melted EPS to an extruding nozzle 48 along the axis of rotating helical flighting. The heated housing 46 comprises heating elements, and in one preferred embodiment, the elements comprise three distinct heating zones capable of reaching different temperatures for progressively heating and melting the EPS. In another preferred embodiment, the heating elements comprise bands surrounding the auger. The extruder 44 is driven by an extruder motor 50, which actuates the Archimedian screw.

A controller is associated with the device for controlling the various motors and heating elements. The controller has controls for altering and setting the speed of the conveyor motor and conveyor belt, and the speed of the crusher motor and speed of the upper and lower crushers. The temperature of the heating elements, including each section of heating elements, and the speed of the extruder is also controlled by controlling the extruder motor.

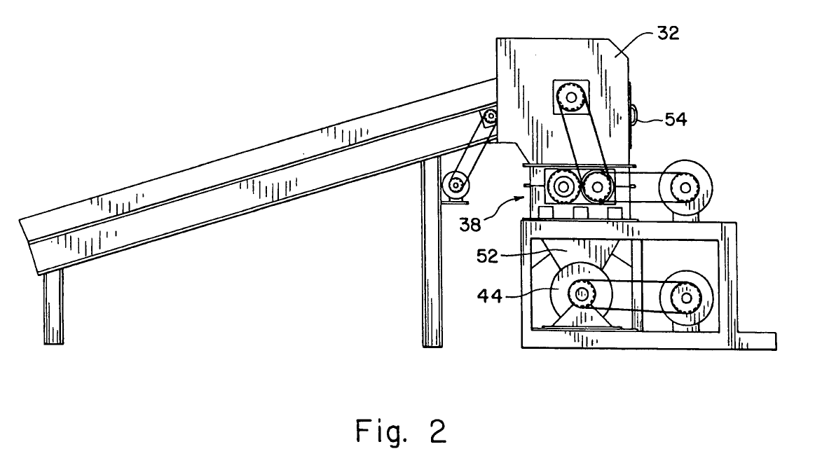

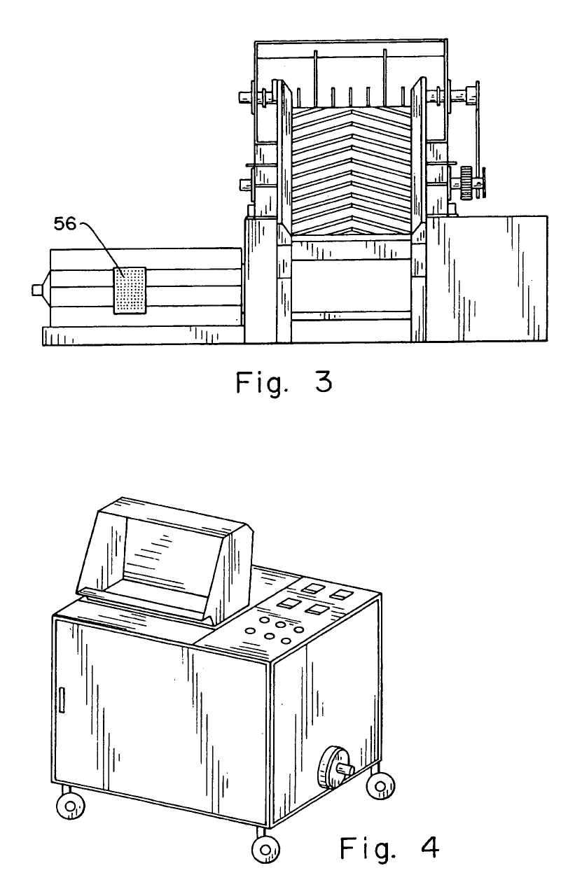

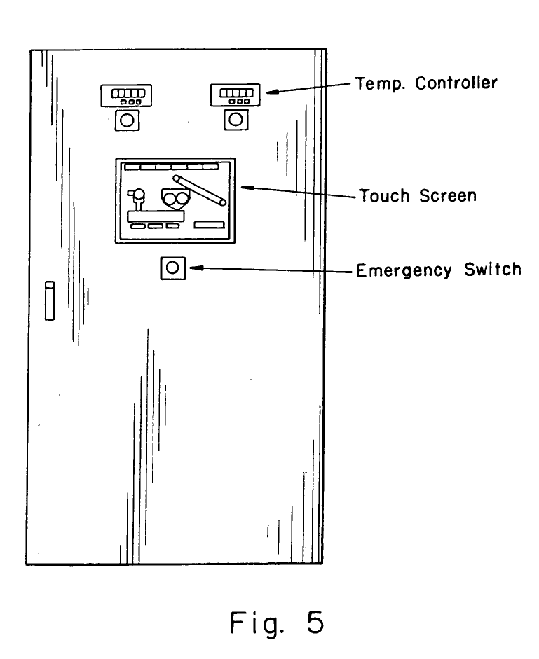

Referring to FIG. 2, a hopper 52 channels crushed EPS material from the lower crusher into the extruder. A back door 54 is disposed on the housing 32 allows access to the upper and lower crushers for maintenance. Referring to FIG. 3, a ventilation panel 56 allows gasses generated from heating the EPS to escape from the device.

Referring to FIG. 4, a smaller version of the device is shown, wherein all parts of the device are housed in a single housing, including the control panel, and the conveyor is omitted. In this embodiment, the controller may also comprise a touch display for controlling the motors and heating elements. Additionally, in any embodiment of the invention, the controller may comprise a touch display, a timer capable of warming up the device automatically at a pre-set time, a temperature regulator to shut off and on and maintain the heating elements at a predetermined temperature, and a means for providing maintenance reminders to operators of the device.

In order to use the device of the present invention, a user places waste EPS into the device by placing the EPS on the conveyor or if no conveyor is used, directly in the housing. The device is then activated, and may have been pre-heated so that recycling can begin immediately once waste EPS is deposited in the device. EPS is fed through the upper and lower crushers, and falls through the screen into the heating element, where the auger urges it, as a liquid, forward through the nozzle of the extruder. A means for collecting the extruded EPS, in one preferred embodiment, a bin, is placed under the nozzle. The bin can be emptied as necessary, and testing has revealed that 7-8 minutes to fill a bin is average. After the device has processed the lasts of the EPS, a user waits until the last of the EPS has left the nozzle. At that point, the device can be deactivated.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A device for recycling extruded polystyrene comprising:
a. a conveyer comprising a conveyor belt, motor, and tensioning means for holding the belt taught;
b. a crusher comprising an upper crushing means for breaking down large polystyrene scrap pieces into smaller polystyrene scrap pieces, and further comprising at least one row of crusher gears for crushing large polystyrene pieces into smaller polystyrene pieces, and a lower crushing means for further breaking down polystyrene scrap pieces from the upper crushing means, and further comprising at least two rows of crusher gears for crushing polystyrene pieces, a crusher motor for turning the upper and lower crushing means, a screen for retaining polystyrene pieces larger than a predetermined size, and allowing polystyrene pieces a the predetermined size or smaller to pass through the screen;
d. an extruder comprising a cylinder means for receiving crushed polystyrene pieces, a heating means for melting polystyrene pieces to a melting point, a screw means for urging melted polystyrene in a predetermined direction under pressure disposed within the cylinder, a nozzle through which melted polystyrene is extruded, a motor for turning the screw means; and
e. a control box capable of controlling the speed of the motors, speed of the upper and lower crushing means, temperature of the heating means, speed of the screw means.

2. The device of claim 1, wherein the conveyor belt is omitted.

3. The device of claim 1, wherein the device comprises a single stand-alone unit, wherein all parts of the device are contained in one housing.

4. The device of claim 1, wherein the conveyor further comprises a means for cutting off the power in an emergency.

5. The device of claim 1, wherein the conveyor further comprises a means for adjusting the speed of the conveyor motor.

6. The device of claim 1, wherein the conveyor transports expanded polystyrene at an angle to the crusher.

7. The device of claim 1, wherein the crusher has an access point with a means for stopping the crusher in an emergency.

8. The device of claim 1, wherein the heating means comprises bands encircling the extruder.

9. The device of claim 8, wherein the extruder comprises a screw encircled by heating bands.

10. The device of claim 1, wherein the heating means is divided into three different sections, each capable of a different temperature setting.

11. The device of claim 1, comprising a ventilation means for allowing vapor generated from melted polystyrene to escape.

12. The device of claim 1, wherein the control box comprises a touch display.

13. The device of claim 1, wherein the control box comprises a timer capable of warming up the device automatically at a pre-set time.

14. The device of claim 1, wherein the control box enables the machine to start operating automatically and shut off the heating means when the heater goes over a preset temp.

15. The device of claim 1, wherein the control box comprises a functionality for providing maintenance reminders to an operator.

16. A method of converting waste expanded polystyrene (EPS) into solid extruded polystyrene comprising the steps of:
a. providing a device for receiving, crushing, melting and extruding polystyrene;
b. activating the device, including heaters, allowing the device to reach a predetermined temperature;
c. placing waste expanded polystyrene into the device and collecting extruded material in a means for collecting extruded polystyrene;

17. The method of claim 16, wherein the bin is emptied every seven to eight minutes.

18. The method of claim 16, wherein the device is left on after use to expel remaining material from the extruder, then deactivated.
